(19) United States
(12) Patent Application Publication
(10) Pub. No.: US 2007/0045894 A1
(43) Pub. Date: Mar. 1, 2007

(54) Process for producing polyolefin films

(76) Inventor: Michael A. McLeod, Kemah, TX (US)

Correspondence Address: FINA TECHNOLOGY INC, PO BOX 674412, HOUSTON, TX, 77267-4412, US

(21) Appl. No.: 11/217,007

(22) Filed: Aug. 31, 2005

(51) Int. Cl. B29C 47/06; B29C 55/06

(52) U.S. Cl. 264/173.15

(57) ABSTRACT

Process for producing an oriented polyolefin film using a multi-component polymer composition provided by a primary polymer component comprising an isotactic propylene homopolymer produced by the polymerization of propylene in the presence of a Ziegler-Natta catalyst and a secondary polymer component comprising a metallocene polymerized isotactic propylene polymer having a xylene solubles content which is less than that of the primary polymer component. The secondary polymer component is a propylene homopolymer or an ethylene-propylene random copolymer having an ethylene content of about 0.5 wt. % or less. The polymer components are separately co-extruded to form a multilayer co-extrudate in which the primary polymer component is present in an amount greater than the secondary polymer component. The multilayer co-extrudate is oriented in at least one direction to form an oriented film.

### FIELD OF THE INVENTION

This invention relates to a process for producing oriented polyolefin films, and more particularly to the use of polyolefin film compositions which incorporate secondary polymer components to provide for improved processability.

### BACKGROUND OF THE INVENTION

Solid state stretching of polyolefins, particularly polypropylenes, produces films which have applications in the polyolefin film business, for example snack food packaging, cigarette overwrap, electronic components wrapping, packaging tape, and shrink film. Film products such as tapes can be formed by orienting a polymer extrudate in a single longitudinal direction. Other film products can be formed by orienting polymers in a plurality of directions such as in stretch blow molding and biaxial orientation. The polymers normally employed in the preparation of films such as biaxially oriented films are isotactic homopolymers with high stereoregularity, although on some occasions the use of syndiotactic polymers has been proposed. Also suitable are co-polymers of isotactic polypropylenes with a small content of ethylene (mini-random co-polymers).

Isotactic polypropylene is one of a number of crystalline polymers which can be characterized in terms of the stereoregularity of the polymer chain. Various stereospecific structural relationships denominated primarily in terms of syndiotacticity and isotacticity may be involved in the formation of stereoregular polymers of various monomers.

Isotactic polypropylene is conventionally used in the production of relatively thin films in which the polypropylene is heated and then extruded through dies and subjected to uniaxial orientation or to biaxial orientation by stressing the film in both a longitudinal direction (referred to as the machine direction) and lateral direction.(sometimes referred to as the tenter direction). The structure of isotactic polypropylene is characterized in terms of the methyl groups attached to the tertiary carbon atoms of the successive propylene monomer units lying on the same side of the main chain of the polymer. That is, the methyl groups are characterized as being all above or below the polymer chain.

Stereoregular polymers, such as isotactic and syndiotactic polypropylene can be characterized in terms of the Fisher projection formula. Another way of describing the structure is through the use of NMR. Bovey's NMR nomenclature for an isotactic pentad is . . . mmmm . . . with each “m” representing a “meso” dyad, or successive methyl groups on the same side of the plane of the polymer chain. As is known in the art, any deviation or inversion in the structure of the chain lowers the degree of isotacticity and crystallinity of the polymer.

Syndiotactic polymers are semi-crystalline and, like the isotactic polymers, have few xylene soluble species. This crystallinity distinguishes both syndiotactic and isotactic polymers from an atactic polymer, which is non-crystalline and highly soluble in xylene. An atactic polymer exhibits no regular order of repeating unit configurations in the polymer chain and forms essentially a waxy product.

### SUMMARY OF THE INVENTION

The present invention involves a process for producing an oriented polyolefin film using multi-component polymer compositions. In carrying out the invention, there is provided a primary polymer component comprising an isotactic propylene homopolymer produced by the polymerization of propylene in the presence of a Ziegler-Natta catalyst. In addition, there is provided a secondary polymer component comprising a metallocene polymerized isotactic propylene polymer having a xylene solubles content which is less than the xylene solubles content of the primary polymer component. The secondary polymer component is a propylene homopolymer or an ethylene-propylene random copolymer having an ethylene content of about 0.5 wt. % or less. The primary and secondary polymer components are separately co-extruded to form a multilayer co-extrudate in which the primary polymer component is present in an amount greater than the amount of the secondary polymer component. The multilayer co-extrudate is oriented in at least one direction to form an oriented film. Preferably, the primary polymer component is present in the co-extrudate in an amount within the range of 80-90 wt. % and the secondary polymer component is present in amount within the range of 10-20 wt. %.

In a further embodiment of the invention, the primary polymer component has a xylene solubles content which is greater than the xylene solubles content of the secondary polymer by a factor of at least three. In addition, the secondary polymer component has a melting temperature which is lower than the melting temperature of the primary polymer component. In a specific embodiment of the invention, the multilayer co-extrudate comprises a base layer formed of the primary polymer component and two film layers formed of the secondary polymer component. The film layers are disposed on opposing surfaces of the base layer to form a three-layer co-extrudate.

In another embodiment of the invention, the film is biaxially oriented by stretching the multilayer co-extrudate in longitudinal and transverse directions. The co-extrudate exhibits a transverse direction yield stress at a designated preheating time which is less than the transverse direction yield stress at the designated preheating time of a corresponding film formed by extruding the primary polymer component alone. In addition, the co-extrudate exhibits a machine direction final draw stress at a designated preheating time which is less than the machine direction final draw stress of a corresponding film formed by extruding the primary polymer component alone. In another aspect of the invention, the extrudate exhibits a transverse direction final draw stress which is less than the corresponding transverse direction final draw stress of a corresponding film formed by the primary polymer component alone.

In yet a further embodiment of the invention, the secondary polymer component is a homopolymer having a xylene solubles content of less than 0.5 wt. % and a melt flow rate of less than 5 decigrams/minute. The primary polymer component is a high crystallinity isotactic propylene homopolymer having a xylene solubles content of no more than 1 wt. %. In a further embodiment, the primary polymer component is an isotactic propylene homopolymer having a xylene solubles content of at least 3 wt. % and a melt flow index which is less than the melt flow index of the secondary polymer component.

In another embodiment of the invention, the polyolefin film is produced from a primary polymer component comprising an isotactic Ziegler-Natta propylene homopolymer having a xylene solubles content of at least 3 wt. %. The secondary polymer component is a metallocene polymerized isotactic propylene polymer as described above. The primary and secondary polymer components are extruded together to provide an extrudate having the primary polymer component in a major amount and the secondary polymer component in a minor amount. The extrudate is stretched in longitudinal and transverse directions to form a biaxially oriented film which exhibits a transverse direction yield stress at the designated preheating time which is less than the transverse direction yield stress at the designated preheating time of a corresponding film formed by extruding the primary polymer component alone.

### BRIEF DESCRIPTION OF THE DRAWINGS

FIG. 1 is a schematic illustration of a tenter-frame system for producing biaxially oriented polypropylene films.

FIG. 2 is a side elevation of a co-extruded film.

FIG. 3 is a graph of transverse direction yield stress versus preheating time for primary polymers and primary polymer—secondary polymer systems exemplary of the invention.

FIG. 4 is a graph of machine direction final draw stress vs. preheating time for the polymer systems of FIG. 3.

FIG. 5 is a graph of transverse final draw stress vs. preheating time for the polymer systems of FIG. 3.

FIG. 6 is a graph of transverse direction apparent toughness vs. preheating time for the polymer system of FIG. 2.

### DETAILED DESCRIPTION OF THE INVENTION

The process of the present invention involves a novel process for the production of oriented polyolefin films such as biaxially oriented films through the use of two polymer components characterized herein as a primary polymer component, which is employed in the predominant amount, and a secondary polymer component, which is employed in a relatively minor amount. The primary polymer component is an isotactic propylene homopolymer which is polymerized using a Ziegler-Natta catalyst which may be of a type as described in greater detail below. The secondary polymer component is a metallocene polymerized propylene homopolymer or a metallocene polymerized ethylene-propylene random copolymer having an ethylene content of about 0.5 wt. % or less. Such copolymers can be produced by the copolymerization of propylene and ethylene, the latter in a relatively small amount, in the presence of an isospecific metallocene catalyst as described below.

The isotactic propylene homopolymers and ethylene-propylene copolymers prepared through the use of conventional Ziegler-Natta catalysts of the type disclosed, for example, in U.S. Pat. Nos. 4,298,718 and 4,544,717, both to Myer et al. Catalysts employed in the polymerization of alpha-olefins may be characterized as supported catalysts or unsupported catalysts, sometimes referred to as homogeneous catalysts. Ziegler-Natta catalysts are normally supported catalysts, such as titanium tetrachloride supported on an active magnesium dichloride as disclosed, for example, in the aforementioned patents to Myer et al. A supported catalyst component, as disclosed in the Myer '718 patent, includes titanium tetrachloride supported on an “active” anhydrous magnesium dihalide, such as magnesium dichloride or magnesium dibromide. The supported catalyst component in Myer '718 is employed in conjunction with a co-catalyst such and an alkylaluminum compound, for example, triethylaluminum (TEAL). The Myer '717 patent discloses a similar compound which may also incorporate an electron donor compound which may take the form of various amines, phosphenes, esters, aldehydes, and alcohols.

Metallocene catalysts as described below, may be employed as unsupported or supported catalyst components. Metallocenes that produce isotactic polyolefins are disclosed in U.S. Pat. No. 4,794,096. These patents disclose chiral, stereorigid metallocene catalysts that polymerize olefins to form isotactic polymers and are especially useful in the polymerization of highly isotactic polypropylene. As disclosed, for example, in the aforementioned U.S. Pat. No. 4,794,096, stereorigidity in a metallocene ligand is imparted by means of a structural bridge extending between cyclopentadienyl groups. Specifically disclosed in this patent are stereoregular hafnium metallocenes which may be characterized by the following formula:
R″(C₅(R′)₄)₂ HFQP (1)
In formula (1), (C₅(R′)₄) is a cyclopentadienyl or substituted cyclopentadienyl group, R′ is independently hydrogen or a hydrocarbyl radical having 1-20 carbon atoms, and R″ is a structural bridge extending between the cyclopentadienyl rings. Q is a halogen or a hydrocarbon radical, such as an alkyl, aryl, alkenyl, alkylaryl, or arylalkyl, having 1-20 carbon atoms and p is 2.

Another preferred isospecific metallocene for use in producing polymers which can be used in the present invention include those incorporating bisindenyl ligand structures. One such ligand structure is a dimethyl silyl-bridged metallocene as characterized by the following formula: 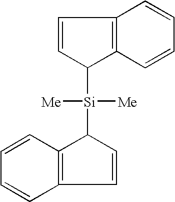
Yet another isospecific metallocene is based upon an isopropylidene-bridged cyclopentadienyl fluorenyl ligand structure in which the cyclopentadienyl group is substituted at the proximal position by a methyl group and at the distal position by a relatively bulky group, such as a tertiary butyl group as indicated by the following formula: 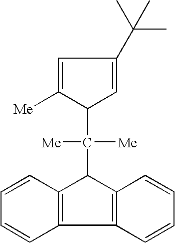
Isospecific metallocenes as described above are disclosed in U.S. Pat. Nos. 5,158,920 and 5,416,228.

The various metallocene structures as described above can be used either as so-called “neutral metallocenes” in which case an alumoxane, such as methylalumoxane, is used as a co-catalyst, or they can be employed as so-called “cationic metallocenes” which incorporate a stable non-coordinating anion and normally do not require the use of an alumoxane. For example, so-called cationic metallocenes are disclosed in U.S. Pat. No. 5,243,002 to Razavi. As disclosed there, the metallocene cation is characterized by the cationic metallocene ligand having sterically dissimilar ring structures which are joined to a positively-charged coordinating transition metal atom. The metallocene cation is associated with a stable non-coordinating counter-anion. Similar relationships can be established for isospecific metallocenes.

While metallocene catalysts are often used as homogeneous catalysts, they also may be supported. As disclosed in U.S. Pat. Nos. 4,701,432 and 4,808,561, both to Welborn, a metallocene catalyst component may be supported on a support or carrier such as talc, an inorganic oxide, or a resinous support material such as a polyolefin. Specific inorganic oxides include silica and alumina, used alone or in combination with other inorganic oxides such as magnesia, zirconia and the like. Non-metallocene transition metal compounds, such as titanium tetrachloride, can also be incorporated into the supported catalyst component. The Welborn '561 patent discloses a heterogeneous catalyst which is formed by the reaction of a metallocene and an alumoxane in combination with the support material. A catalyst system embodying both a homogeneous metallocene component and a heterogeneous component, which may be a “conventional” supported Ziegler-Natta catalyst, e.g. a supported titanium tetrachloride, is disclosed in U.S. Pat. No. 5,242,876 to Shamshoum et al. Various other catalyst systems involving supported metallocene catalysts are disclosed in U.S. Pat. No. 5,308,811 to Suga et al and U.S. Pat. No. 5,444,134 to Matsumoto.

Polyolefin compositions which can be oriented at variable process conditions, particularly over a range of machine direction orientation draw ratios and transverse direction orientation oven temperatures, are desirable for a number of reasons. Film manufacturers have the flexibility to vary one or more processing conditions within an acceptable range for a particular film production run. In addition, the possibility of a web break during the orientation process is lessened, resulting in lower processing line start up costs. For example, a standard machine direction orientation draw ratio is about 5 times the original length of the polyolefin film. A standard transverse direction oven temperature is about 166° C. These processing conditions are considered standard in that the occurrence of web breaks in the film are infrequent. The ability to orient film compositions under variable conditions, for example a machine direction draw ratio within the range of its standard up to 9 times the original length, and a transverse direction oven temperature within the range of its standard to about 20° C. less than the standard, gives manufacturers greater latitude in the production of film products. A further processing advantage is the ability to draw the film at higher line speeds thereby decreasing the manufacturing time.

Biaxially-oriented films can have a number of properties to their advantage during and after the machine processing steps. A relatively low coefficient friction is desirable, both during the biaxially orientation procedure and in the use of the ultimately-produced biaxially-oriented film for end use applications. A relatively high stiffness, as indicated by tensile moduli in both the machine direction and the transverse direction is usually advantageous. The 1% secant modulus is a measure of the stiffness of the oriented film after it is stretched by 1% after orientation. The secant modulus is normally much higher than the machine direction strength. Relatively low permeabilities to gas and water are desirable. In addition, a high shrinkage factor of the processed film, while undesirable in some cases, can be advantageous in others, such as where the film is used in stretch wrapping of food products, electrical components, and the like.

Properties of the resulting film product can be dependent to a certain degree on the particular process conditions under which the polyolefin composition was manufactured. For example, a stiffer film with a higher shrinkage factor and better barrier properties would result from an orientation process incorporating a larger machine direction orientation draw ratio. Likewise, the transverse direction orientation oven temperature would affect the properties of the resulting oriented film product, particularly improving the shrinkage factor.

The physical and optical properties of films are important in the film industry and should fall within certain parameters for different film applications. The optical properties include haze, contact clarity (NAS), and gloss. Haze is a phenomena of light scattering and arises from local variations in the refractive index. Haze is defined as the relative fraction of scattered intensity from the dispersed particles in all directions, being detected in a range of wide angle, to the incident light intensity. Contact clarity or NAS is a measure of contact clearness or see-through quality and is different from haze due to the direct transmittance of light. For example, some films may indeed be hazy but appear clear as the film is in contact with the contents of a package. Unlike haze, NAS clarity is distance dependent so that the thinner the film, the better the contact clarity. Gloss is defined as the ratio of the reflected light intensity from the film at a specific angle of incidence light to that of a standard with the ideal smooth surface.

As noted previously, biaxially oriented films are characterized in terms of certain well-defined characteristics relating to their stereoregular structures and physical properties, including melt temperatures and shrinkage characteristics, as well as in relatively low coefficients of friction and relatively high tensile moduli and good barrier properties including relatively low permeation rates to oxygen and water. The biaxially-oriented films of the present invention are formed using composition of particularly configured primary and secondary polymer components as described in greater detail below and by using any suitable oriented film production technique, such as the conventionally-used tenter frame process.

The present invention addresses oriented films involving the combination of two isotactic polymers in a polymer blend which is extruded and oriented. The polymer blend may also include minor amounts (typically less than 1 wt. %, and more typically less than 0.5 wt. %) of additives designed to enhance other physical or optical properties. Such mixtures may have, for example, one or more antioxidants present in an amount totaling no more than about 0.25 wt. % and one or more acid neutralizers present in an amount totaling no more than about 0.25 wt. %. Additives acting as anti-block agents may also be present, again in relatively low percentages such as no more than about 1 wt. %, more preferably no more than about 0.5 wt. %, and even more desirably no more than about 0.25 wt. %.

The use of primary and secondary polymer components in accordance with the invention improves the processability of the polyolefin composition in forming the film. During biaxial orientation, the occurrence of web breaks in the film of the present invention is less frequent at standard machine direction orientation draw ratios and transverse direction orientation oven temperatures. Accordingly, the draw ratios in the machine direction can be increased and the oven temperatures of the transverse direction orientation can be lowered while processing the composition of the present invention with few web breaks. In addition, the drawability of the polyolefin composition can be accomplished at higher line speeds. The polyolefin compositions used in the present invention are desirable in that these physical and optical properties of the resulting film product are not significantly altered by the variable processing conditions.

In general, biaxially oriented film production can be carried out by any suitable technique, such as disclosed for example, in Canadian Patent Application No. 2,178,104 to Peiffer et al. As described in the Peiffer et al application, the entire disclosure of which is incorporated herein by reference, the polymers used to make the film are melted and then passed through an extruder to a slot die mechanism after which it is passed over a first roller, characterized as a chill roller, which tends to solidify the film. The film is then oriented by stressing it in a longitudinal direction, characterized as the machine direction, and in a transverse direction to arrive at a film which can be characterized in terms of orientation ratios, sometimes also referred to as stretch ratios, in both longitudinal and transverse directions. The machine direction orientation is accomplished through the use of two sequentially disposed rollers, the second or fast roller operating at a speed in relation to the slower roller corresponding to the desired orientation ratio. This may alternatively be accomplished through a series of rollers with increasing speeds, sometime with additional intermediate rollers for temperature control and other functions. After the film has been stressed in the machine direction, it is again cooled and then pre-heated and passed into a lateral stressing section, for example, a tenter frame mechanism, where it is again stressed, this time in the transverse direction. Orientation in the transverse direction is often followed by an annealing section. Subsequently, the film is then cooled and may be subjected to further treatment, such as a surface treatment (for example corona treatment or flame treatment), as described, for example, in the aforementioned Canadian Patent Application No. 2,178,104 or in U.S. Pat. No. 4,692,380 to Reid, the entire disclosure of which is incorporated herein by reference. The film may also be metallized as described in U.S. Pat. No. 4,692,380 to Reid. While corona and flame treatment typically occurs immediately following orientation and prior to the initial roll up, metallizing is typically performed at a separate time and location.

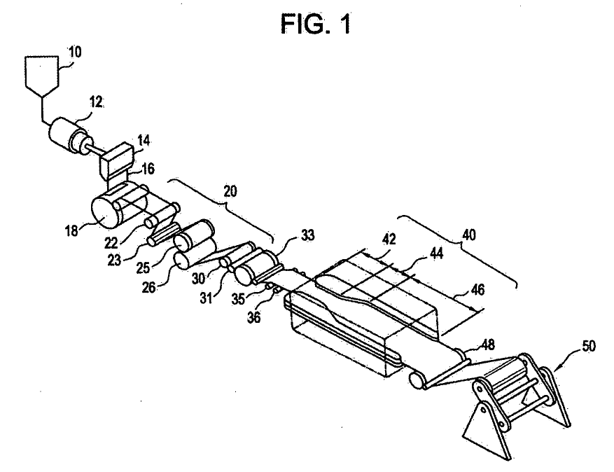

Turning now to FIG. 1, there is shown a schematic illustration of a suitable “Tenter Frame” orientation process which may be employed in producing biaxially-oriented polypropylene film in accordance with the present invention. More particularly and with reference to FIG. 1, a source of molten polymer is supplied from a heated hopper 10 to an extruder 12 and from there to a slot die 14 which produces a flat, relatively thick film 16 at its output. Film 16 is applied over a chill roller 18, and it is cooled to a suitable temperature within the range of about 30-60° C. The film is drawn off the chill roller 18 to a stretching section 20 to which the machine direction orientation occurs by means of idler rollers 22 and 23 which lead to preheat rollers 25 and 26.

As the film is drawn off the chill roller 18 and passed over the idler rollers, it is cooled to a temperature of about 30-60° C. In stretching the film in the machine direction, it is heated by preheat rollers 25 and 26 to an incremental temperature increase of about 60-100° C. and then passed to the slow roller 30 of the longitudinal orienting mechanism. The slow roller may be operated at any suitable speed, usually about 20-40 feet per minute in this type of pilot production line. The fast roller 31 is operated at a suitable speed, typically about 150 feet per minute in a pilot line, to provide a surface speed at the circumference of about 4-7 times that of the slow roller in order to orient the film in the machine direction. In a commercial production line, casting speeds may be much higher such as 20-60 meters per minute, with 120-360 meters per minute in final speeds.

As the oriented film is withdrawn from the fast roller, it is passed over a roller 33 at room temperature conditions. From here it is passed over tandem idler rollers 35 and 36 to a lateral stretching section 40 where the film is oriented by stretching in the transverse direction. The section 40 includes a preheat section 42 comprising a plurality of tandem heating rollers (not shown) where it is again reheated to a temperature within the range of 130-180 ° C. From the preheat section 42 of the tenter frame, the film is passed to a stretching or draw section 44 where it is progressively stretched by means of tenter clips (not shown) which grasp the opposed sides of the film and progressively stretch it laterally until it reaches its maximum lateral dimension. Lateral stretching ratios are typically greater than machine direction stretch ratios and often range anywhere from 5-12 times the original width. Ratios of 8-10 times are usually preferred. The concluding portion of the lateral stretching phase includes an annealing section 46, such as an oven housing, where the film is heated at a temperature within the range of 130-170° C. for a suitable period in time, about 1-10 seconds. The annealing time helps control certain properties, and increased annealing is often specifically used to reduce shrinkage. The biaxially oriented film is then withdrawn from the tenter frame and passed over a chill roller 48 where it is reduced to a temperature of less than about 50° C. and then applied to take-up spools on a take-up mechanism 50. From the foregoing description, it will be recognized that the initial orientation in the machine direction is carried out at a somewhat lower temperature than the orientation in the lateral dimension. For example, the film exiting the preheat rollers is stretched in the machine direction at a temperature of about 120° C. The film may be cooled to a temperature of about 50° C. and thereafter heated to a temperature of about 160° C. before it is subject to the progressive lateral dimension orientation in the tenter section.

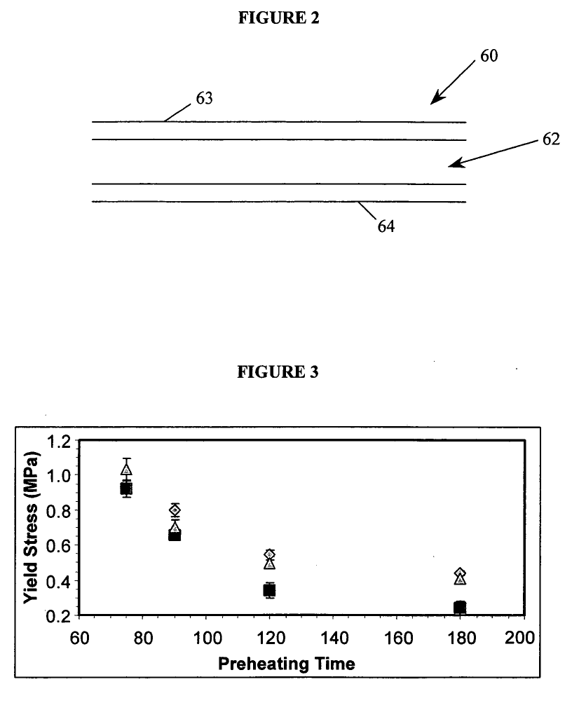

Tapes and other films which are oriented only in the machine direction can be prepared using a system similar to that shown in FIG. 1 but without the provision of the lateral stretching section 40. In this case, the film is passed directly from the idler rollers to takeup mechanism 50. The present invention can also be applied to other processes in which the produced film is oriented in several directions. For example, stretch blow molding processes may be employed in which the primary and secondary polymer components are co-injection molded to produce a cylindrical preform which can be expanded by internal pressure, such as disclosed in U.S. Pat. No. 6,749,785. Systems such as those disclosed in FIG. 1 and described above can be used to produce multilayer co-extrudates which are then oriented in one or more directions. In this case, the primary component and secondary component, rather than being mixed together prior to extrusion through the die, are separately extruded through parallel dies to form the multilayer extrudates which are then stretched to produce the oriented film of the present invention. The multilayer extrudates may be in the form of a relatively thick base layer formed of the primary polymer component and a relatively thin film layer formed of the secondary polymer component adjacent to the base layer. Preferably, the co-extrudates deployed in the present invention comprise an internal base layer formed of the primary polymer component with two film layers formed of the secondary polymer component on the opposed surfaces of the base layer. In either case, the secondary polymer component, whether it is formed in one layer or two layers, is present in an amount preferably within the range of 10-20 wt. % of the total polymer system. FIG. 2 is a side elevational view of such a three-layer co-extrudate. Thus, as shown in FIG. 2, the three-layer extrudate comprising a base or core layer 62 formed of the primary polymer component, and adjacent surface layers 63 and 64 formed of the secondary polymer component. As will be recognized by those skilled in the art, a three-layer extrudate as shown in FIG. 2, can be prepared employing a system similar to that shown in FIG. 1 with an extruder and slot die mechanism having a relatively thick die dimension to form the core layer and adjacent opposed relatively thin die forming the contiguous surface layers. As indicated by the experimental data discussed below, the multi-component polymer system can be employed to provide reduced values in terms of yield stresses and final draw stresses, as well as transverse direction apparent toughness which is lower than corresponding film formed of the primary polymer component alone. Surprisingly, these lower processing values which translate to enhanced processing of the film during orientation, apply for the co-extruded systems as well as the systems in which a blend of primary and secondary polymer components is extruded as a mixture.

The present invention provides a process for the production of polyolefin films in which solid state stretching is eased during the film forming process while maintaining or enhancing desirable film properties, such as good gloss characteristics and reduced haze. The invention is carried out with at least two polymer components characterized herein as a primary polymer component and a secondary polymer component. The primary polymer component is isotactic polypropylene which is produced in the presence of a Ziegler-Natta catalyst as described previously. The primary polymer component is the predominant polymer in the multi-component polymer mixture. The secondary polymer component is a metallocene polymerized propylene homopolymer or an ethylene-propylene random copolymer which is present in a relatively small amount.

Exemplary of primary polymer composition which may be employed in the present invention are two isotactic Ziegler-Natta based isotactic polypropylenes identified herein as Polymer P1 and Polymer P2. Polymer P1 is a very high crystallinity isotactic polypropylene having a xylene solubles content of about 1 wt. % or less. Polymer P2, exemplary of another primary polymer component which can be employed in carrying out the present invention, is a Ziegler-Natta polymerized propylene homopolymer having a somewhat higher xylene solubles content than Polymer P1. Polymer P2 has a xylene solubles content of about 3.8 wt. % as contrasted with the xylene solubles content of about 0.8 wt. % for Polymer P1. Polymer P1 has a melt temperature of about 165° C. and a crystallization temperature of 110.6° C. Polymer P2 exhibits a melt temperature of 160.7° C. and a crystallization temperature of 116.1° C.

In experimental work respecting the present invention, Polymer P2 was used alone and in conjunction with a secondary polymer component, designated herein as Polymer S1. Polymer S1 is a metallocene-based propylene homopolymer having a xylenes content of about 0.23 wt. % and a melt flow index of 4.0, somewhat above the melt flow index of 2.7 for Polymer P2. The melt flow indices as quoted herein are based upon the melt flow rates for the polymers as determined in accordance with ASTM D-1238. Polymer S1 had a melt temperature 150° C. and a crystallization temperature of 106° C.

In the experimental work, three types of 80 mil thick polymer sheets were prepared and subjected to machine direction and transverse direction stretching at draw ratios of 6 in each case. One sheet was formed of pure Polymer P2 to provide a baseline for the processability parameters observed. A second sheet was formed from a blend of Polymer P2 and the secondary polymer component, Polymer S1. The polymer blend, which was extruded to form the test sheets, contained 84 wt. % Polymer P2 and 16 wt. % of the secondary polymer S1. The final test sheet was co-extruded to form a three-layered structure which contained the primary and secondary polymer components in the same relative amounts as used in the blended structure. Here, the three-layered structure had two surface layers formed of the pure secondary polymer component Polymer S1 and a core layer formed of the pure primary polymer component, Polymer 3371. The core layer made up 84 wt. % of the co-extruded structure and the two surface layers each provided 8% of the total weight of the sheet. The three sheets were subjected to 6×6 simultaneous stretching (to simulate biaxial orientation) over a range of preheating times varying from 70 seconds to 180 seconds. The sheets were evaluated in terms of transverse direction yield stress, machine direction final draw stress, transverse direction final draw stress and transverse direction apparent toughness.

The transverse direction yield stress, in terms of increasing preheating times, is illustrated in FIG. 3 which shows yield stress in MPa plotted on the ordinate vs. the preheating time in seconds plotted on the abscissa. In FIG. 3, the yield stress for the pure Polymer P2 is indicated by ⋄ with the values for the blended sheet containing 84% Polymer P2 and 16 wt. % Polymer S1 indicated by data points ▪ and the data points for the co-extruded sheets indicated by data points Δ. At the minimum preheating time of 75 seconds for the sheet formed of pure Polymer P2, the sheet could not be successfully drawn. At the higher preheating times (from 90 seconds up to the maximum 180 seconds), both the blended structure and the co-extruded structure showed reduced transverse direction yield stress compared with the sheet formed of the pure Polymer P2. The data of FIG. 3 indicates both the co-extruded structure and the blended structure can be processed at faster line speeds using equipment such as that shown in FIG. 1.

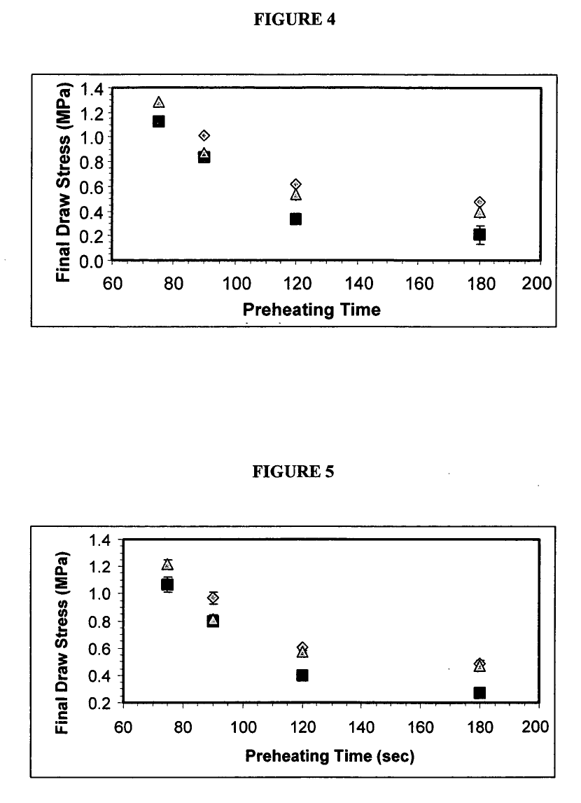

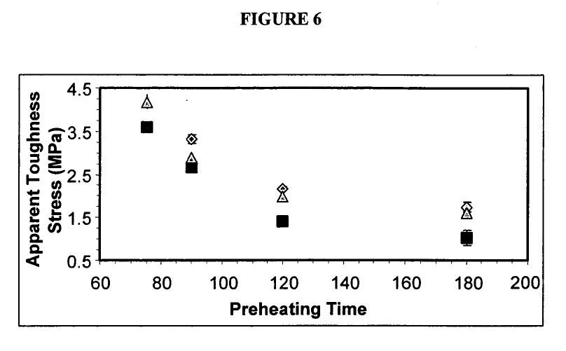

The increased processability characteristics indicated in FIG. 3 were confirmed by final draw stress data for the machine direction and transverse direction as shown in FIGS. 4 and 5, respectively. In FIGS. 4 and 5, the machine direction final draw stress and the transverse direction final draw stress are plotted on the ordinate vs. the preheating time in seconds on the abscissa, with the same data points as used in FIG. 3. The final draw stress parameters for the co-extruded system were substantially the same as for the blended system at a preheating time of 90 seconds and remained somewhat better at the longer preheating time of 120 seconds. FIG. 6 shows the apparent toughness in MPa plotted on the ordinate vs. preheating time plotted on the abscissa for the three systems using the same data points as used in FIG. 3.

As can be seen from an examination of the data presented in FIGS. 3-5, drawing for the multi-component polymer system is facilitated not only for the blended system, but also for the separately co-extruded system. Drawing for the co-extruded system is substantially easier for the preheating time of 90 seconds, and remains better at 120 seconds and also at 180 seconds, at least in terms of the final draw stress characteristics shown in FIG. 3 and the apparent toughness shown in FIG. 5.

Having described specific embodiments of the present invention, it will be understood that modifications thereof may be suggested to those skilled in the art, and it is intended to cover all such modifications as fall within the scope of the appended claims.

1. In a process for producing a polyolefin film comprising:
(a) providing a primary polymer component comprising an isotactic propylene homopolymer produced by the polymerization of propylene in the presence of a Ziegler-Natta catalyst;
(b) providing a secondary polymer component comprising a metallocene-polymerized propylene polymer having a xylene solubles content which is less than the xylene solubles content of said primary polymer component selected from the group consisting of:
(i) a propylene homopolymer; and
(ii) an ethylene-propylene random copolymer having an ethylene content of about 0.5 wt. % or less;
(c) separately co-extruding said primary and secondary polymer components together to form a multilayer co-extrudate of said primary and secondary polymer components in which the primary polymer component is present in an amount which is greater than the amount of said secondary polymer component; and
(d) forming an oriented film of said polymer components by stretching said multilayer co-extrudate in at least one direction.

2. The process of claim 1 in which said primary polymer component is present in said co-extrudate in an amount within the range of 80-90 wt. % and said secondary polymer component is present in an amount within the range of 10-20 wt. %.

3. The process of claim 2 in which the primary polymer component has a xylene solubles content which is greater than the xylene solubles content of said secondary polymer component by a factor of at least 3.

4. The process of claim 1 wherein said secondary polymer component has a melting temperature which is lower than the melting temperature of said primary polymer component.

5. The process of claim 1 wherein said multilayer co-extrudate comprises a base layer formed of said primary polymer component and film layer on the opposed surfaces of the base layer formed of said secondary polymer component.

6. The process of claim 1 wherein said film is biaxially oriented by stretching said multilayer co-extrudate in longitudinal and transverse directions.

7. The process of claim 6 wherein said multilayer co-extrudate exhibits a transverse direction yield stress at a designated preheating time which is less than the transverse direction yield stress at said designated preheating time of a corresponding film formed by extruding said primary polymer component alone.

8. The process of claim 6 wherein said multilayer co-extrudate exhibits a machine direction final draw stress at a designated preheating time which is less than the machine direction final draw stress at said designated preheating time of a corresponding film formed by extruding said primary polymer component alone.

9. The process of claim 6 wherein said multilayer co-extrudate exhibits a transverse direction final draw stress at a designated preheating time which is less than the transverse direction final draw stress at said designated preheating time of a corresponding film formed by extruding said primary polymer component alone.

10. The process of claim 6 wherein said multilayer co-extrudate exhibits a transverse direction apparent toughness at a designated preheating time which is less than the transverse direction apparent toughness at said designated preheating time of a corresponding film formed by extruding said primary polymer component alone.

11. The process of claim 1 wherein said secondary polymer component is a metallocene polymerized propylene homopolymer having a xylene solubles content of less than 0.5 wt. %.

12. The process of claim 11 wherein said metallocene polymerized propylene homopolymer has a melt flow rate of less than 5 decigrams/minute.

13. The process of claim 12 wherein said primary polymer component is a high crystallinity isotactic propylene homopolymer having a xylene solubles content of no more than 1 wt. %.

14. The process of claim 12 wherein said primary polymer component is a isotactic propylene homopolymer having a xylene solubles content of at least 3 wt. % and a melt flow index which is less than the melt flow index of said secondary polymer component.

15. In a process for producing a polyolefin film comprising:
(a) providing a primary polymer component comprising an isotactic propylene homopolymer produced by the polymerization of propylene in the presence of a Ziegler-Natta catalyst, said isotactic propylene homopolymer having a xylene solubles content of at least 3 wt. %;
(b) providing a secondary polymer component comprising a metallocene-polymerized propylene polymer having a xylene solubles content which is less than the xylene solubles content of said primary polymer component selected from the group consisting of:
(i) a propylene homopolymer; and
(ii) an ethylene-propylene random copolymer having an ethylene content of about 0.5 wt. % or less;
(c) extruding said primary and secondary polymer components together to provide an extrudate of said primary and secondary polymer components in which the primary polymer component is present in an amount which is greater than the amount of said secondary polymer component; and
(d) stretching said extrudate in longitudinal and transverse directions to form a biaxially oriented film of said polymer components which exhibits a transverse direction yield stress at a designated preheating time which is less than the transverse direction yield stress at said designated preheating time of a corresponding film formed by extruding said primary polymer component alone.

16. The process of claim 15 wherein said biaxially oriented film exhibits a machine direction final draw stress at a designated preheating time which is less than the machine direction final draw stress at said designated preheating time of a corresponding film formed by extruding said primary polymer component alone.

17. The process of claim 15 wherein said biaxially oriented film exhibits a transverse direction final draw stress at a designated preheating time which is less than the transverse direction final draw stress at said designated preheating time of a corresponding film formed by extruding said primary polymer component alone.

18. The process of claim 15 wherein said biaxially oriented film exhibits a transverse direction apparent toughness at a designated preheating time which is less than the transverse direction apparent toughness at said designated preheating time of a corresponding film formed by extruding said primary polymer component alone.

19. The process of claim 15 in which said primary polymer component is present in said extrudate in an amount within the range of 80-90 wt % and said secondary polymer component is present in an amount within the range of 10-20 wt. %.

20. The process of claim 19 in which the primary polymer component has a xylenes content which is greater than the xylenes content of said secondary polymer component by a factor of at least 3.

21. The process of claim 19 wherein said secondary polymer component has a melting temperature which is lower than the melting temperature of said primary polymer component.
